(19) United States
(12) Patent Application Publication
(10) Pub. No.: US 2006/0210663 A1
(43) Pub. Date: Sep. 21, 2006

(54) MODULES FOR CO-EXTRUSION DIES

(76) Inventor: RAFAEL CASTILLO, Hamilton (CA)

Correspondence Address: MARK A KOCH, 866 MAIN STREET EAST, HAMILTON, ON, L8M1L9, CA

(21) Appl. No.: 11/308,168

(22) Filed: Mar. 9, 2006

(30) Foreign Application Priority Data
Mar. 16, 2005 (US) 60/661,924

(51) Int. Cl. B29C 47/00

(52) U.S. Cl. 425/133.1

(57) ABSTRACT

The present invention is a module used in a modular blown film co-extrusion die for extruding multi layer polymer materials in a tubular form. The module including an upper pancake section including an upper melt entry port and melt channels defined in one face thereof, wherein the melt channels communicating fluidly with the upper melt entry port and a lower pancake section including a lower melt entry port and melt channels defined in one face thereof, wherein the melt channels communicating fluidly with the lower melt entry port. The melt channels of the upper and lower pancake sections facing each other and separated by a divider plate, such that the upper pancake section together with one side of the divider plate defining a top melt path and the lower pancake section together with the other side of the divider plate defining a bottom melt path, wherein the top melt path producing a top melt layer and the bottom melt path producing a bottom melt layer.

### CROSS REFERENCE TO RELATED APPLICATIONS

The application claims priority from previously filed U.S. provisional patent application No. 60/661,924, titled “Co-extrusion Dies” on Mar. 16, 2005 by Rafael Castillo.

### FIELD OF THE INVENTION

The invention relates to co-extrusion dies for extruding multilayer polymer materials into a singular tubular form. It particular it relates to a module used in side fed modular blown film dies.

### BACKGROUND OF THE INVENTION

Many areas of polymer processing require multiple layers of different polymers to be co-extruded into a single tubular form. One example is the blown film process which is used to make most of today's commodity bags and also high barrier food packaging. Although multi-layer packaging can be made from co-extruded flat film, using a tubular form presents fewer sealing operations, results in less trim scrap and is more conducive to certain product shapes.

Tubular forms are used in many applications including the production of multi-layer pipe or tubing, pipe coating, wire coating, and the production of multi-layer parisons for blow molding. Tubular parisons are used in making containers of various shapes as annular dies are typically easier to manufacturer than dies of other shapes, such as oval or square. Annular co-extrusion dies are commonly used to process high volume commodity resins as well as relatively low volumes of barrier type resins.

Annular co-extrusion dies are generally of one of two arrangements; namely axially fed and radially fed. In either type of arrangement, melt is introduced into an inlet port from where it has to be evenly distributed about the circumference of an annular outlet. Good flow distribution is essential to forming film having layers which are uniform in thickness, appearance and structural integrity. In axially fed co-extrusion dies, melt is fed in a direction parallel to the axis of the tubular form to be extruded. Each layer is formed between respective die elements which are generally concentrically disposed in a manner analogous to cups of different diameter stacked on with an other. The individual layers are merged upstream in an extrusion passage through which the co-extruded film is discharged.

In radially fed co-extrusion dies, melt distribution blocks are stacked one behind another along a die axis and melt is fed radially relative to the die axis into a respective inlet port in each melt distribution block. The melt distribution blocks distribute the melt about a central mandrel and discharge the melt in an axial direction into an extrusion passage between the melt distribution blocks and the mandrel. Each consecutive melt distribution block applies an overlying melt layer to the melt moving along the extrusion passage.

Axially stacked radially or side fed co-extrusion dies are advantageous in that it is relatively simple to vary the number of layers by varying the number of “modules” stacked axially. Furthermore, each level presents a similar area and the levels are more easily thermally isolated than possible with axially fed co-extrusion dies in which heat from one die element is difficult to isolate from adjacent die elements. Even melt distribution is however a much more challenging problem with radially fed co-extrusion dies because of a much shorter axial distance being available for melt equalization and the requirement to redirect melt flow from a radial to an axial direction after the melt has been distributed into a thin film.

It is an object of the present invention to provide a module for a radially fed multi-layer extrusion die which is effective in providing a uniformly thick film of melt to an extrusion passage.

It is an object of the present invention to provide modular stacked radially fed multi-layer extrusion die which is effective in providing a uniformly thick film of melt to an extrusion passage.

It is a further object of the present invention to provide a melt distribution block for a radially fed multi-layer extrusion die which can accept and combine different types of melt.

### SUMMARY OF THE INVENTION

The present invention is a module used in a modular blown film co-extrusion die for extruding multi layer polymer materials in a tubular form, the module comprising:

(a) an upper pancake section including an upper melt entry port and melt channels defined in one face thereof, wherein the melt channels communicating fluidly with the upper melt entry port,

(b) a lower pancake section including a lower melt entry port and melt channels defined in one face thereof, wherein the melt channels communicating fluidly with the lower melt entry port, and

(c) wherein the melt channels of the upper and lower pancake sections facing each other and separated by a divider plate, such that the upper pancake section together with one side of the divider plate defining a top melt path and the lower pancake section together with the other side of the divider plate defining a bottom melt path, wherein the top melt path producing a top melt layer and the bottom melt path producing a bottom melt layer.

Preferably wherein the divider plate being substantially planar.

Preferably wherein the divider plate having substantially smooth upper and lower surfaces.

Preferably wherein the divider plate including an upturned end.

Preferably wherein each melt entry port operably dimensioned to be fed by individual extruders.

The present invention also includes a modular blown film co-extrusion die for extruding multi-layer polymer materials in tubular form comprising at least one module as claimed in claim 1,2 or 3 including at least two melt entry ports wherein each entry port operably adapted to be fed by individual extruders and wherein each module capable of producing two independent melt layers.

The present invention also includes a blown film co-extrusion die for extruding multi-layer polymer materials in tubular form comprising at least two modules as claimed in claim 1,2, or 3 stacked one on top of the other, the co-extrusion die including at least four melt entry ports wherein each entry port operably adapted to be fed by individual extruders and wherein each module capable of producing two independent melt layers.

Preferably further including an external melt inlet divider for communicating polymer melts to multiple melt entry ports the external melt inlet divider including:

(a) a melt pipe defining a melt flow channel for communicating melts there through,

(b) a means for splitting the melt into at least two separate paths for communicating melt to at least two individual melt entry ports.

Preferably wherein the splitting means includes a splitter block rigidly attached at one end of the melt pipe, the splitter block including an upper melt channel for communicating to an upper melt entry port and a lower melt channel for communicating melt to a lower melt entry port.

Preferably wherein the splitter block further including a valve, wherein the valve for controlling the division of melt flow within the splitter block thereby controlling the melt flow to each melt entry port.

### BRIEF DESCRIPTION OF THE DRAWINGS

The invention will now be described by way of example only with reference to the following drawings in which:

FIG. 1 is a schematic side cross-sectional view of a radial (side) fed modular blown film co-extrusion die shown with melt inlet dividers attached.

FIG. 2 is a top plan view of a side fed modular blown film co-extrusion die with some melt inlet dividers attached.

FIG. 3 is a schematic cross-sectional view of a melt inlet divider, together with a valve.

FIG. 4 is a side cross-sectional schematic view of a radial (side) fed modular blown film co-extrusion die having three vertically stacked modules shown with two melt inlet dividers mounted thereon without valves.

FIG. 5 is a top plan view of a pancake section showing the melt entry ports, melt channels and melt spirals.

FIG. 6 is a side cross-sectional view of a radial (side) fed modular blown film co-extrusion die, together with some single melt inlets, rather than melt inlet dividers as shown in FIG. 1.

FIG. 7 is a top cross-sectional schematic view of the side said modular blown film co-extrusion die shown in FIG. 6, together with some single melt inlets attached.

FIG. 8 is a schematic cross-sectional view of one prior art co-extrusion module section showing one internal melt divider.

FIG. 9 is a schematic cross-sectional view of one co-extrusion module according to the present invention.

FIG. 10 is a side cross-sectional view of a radial (side) fed modular blown film co-extrusion die, together with one melt inlet divider delivering melt to two separate modules.

### DETAILED DESCRIPTION OF THE PREFERRED EMBODIMENT

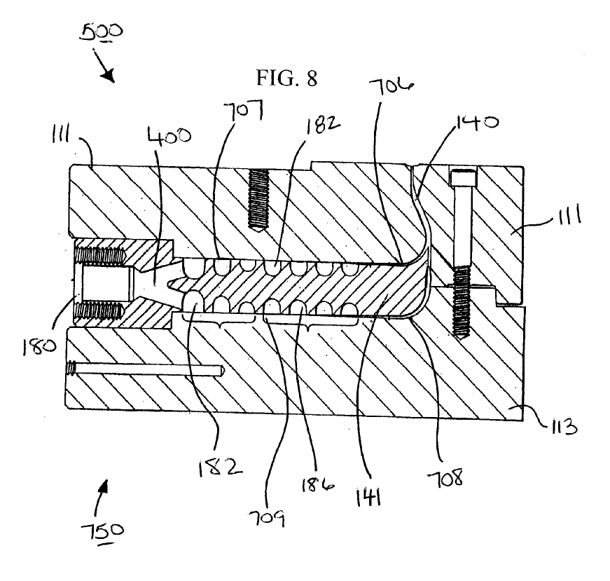

Referring first of all to FIG. 8, showing the existing prior art devices,

FIG. 8 shows one module of a current side fed modular blown film die 500 having a path divider 141 having melt channels 182 and melt spirals 186 defined on the bottom and top thereof. The module has defined therein an internal melt divider 400 and a single die entry port 180. The prior art path divider 141 has defined on the top surface thereof, a top melt path 707 creating a top melt layer 706. The bottom of prior art divider 141 defines a bottom melt path 709, creating a bottom melt layer 708. In prior art device, prior art pancake section 111 is installed on top of the prior art path divider 141 and prior art pancake section 113 is placed on the bottom of prior art path divider 141. The combination of prior art path divider 141 together with the two prior art pancake sections 111 and 113 creates one module 750.

In the prior art device, the melt is divided after entry into the module in other words internally after the die entry port 180. Melt division occurs internally in the prior art path divider 141 and therefore provides no flexibility in terms of being able to select and/or control externally the division of melts into the melt channels 182. This arrangement restricts the number of individual and separate melts that can be fed into prior art side fed modular blown film die 500 without having to disassemble the unit.

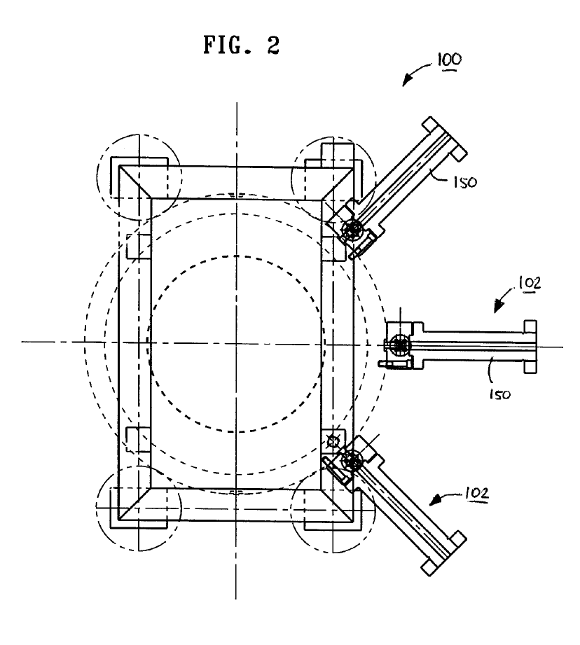

It will become apparent to the reader that the presently invented module 850 having external melt inlet dividers 102 provides for greater flexibility in terms of selection of number and type melts fed into the die as well as reduction in cost of operating the side fed modular blown film co-extrusion dies. In addition pancake sections 110 can be rotated about the axial direction 128 in order to stagger melt inlet ports so that the one can select to either have adjacent melt inlet ports stacked one on top of the other in other words aligned along the axial direction or staggered such that the melt extruders attached to each melt pipe 150 do not interfere with the one above or below as shown in FIG. 2 for example. Therefore with 6 pancake sections 110 one could have six independent melt pipes 150 feeding 6 independent melt entry ports 180 all of which are staggered around the outside of the modular blown film co-extrusion die 100. The reader will know that each individual melt entry port 180 can be fed with a single melt pipe 150 wherein each melt pipe 150 is fed by an individual melt extruder.

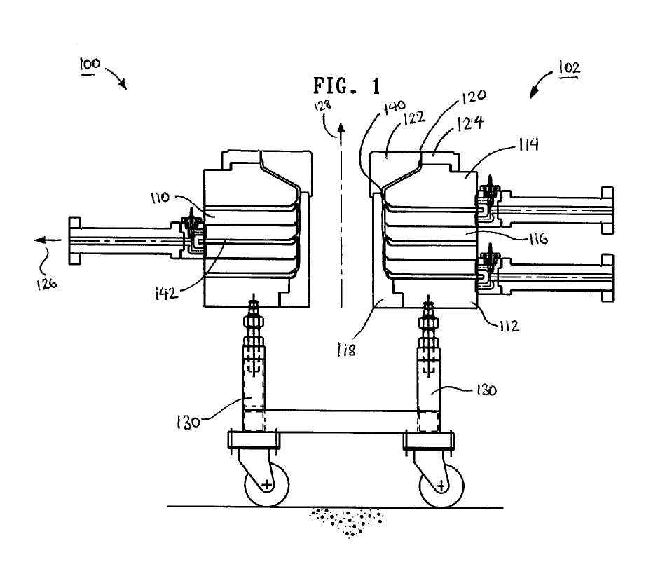

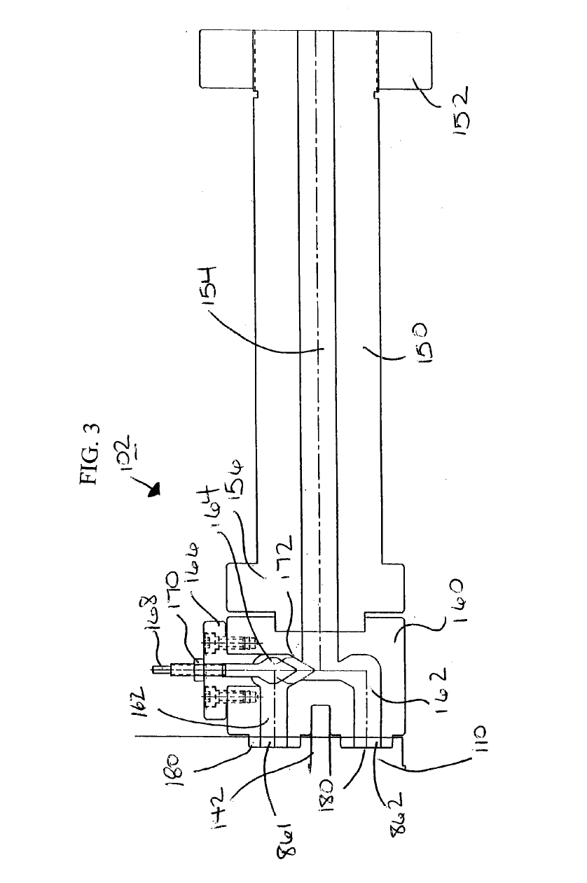

The present invention is depicted in FIGS. 1 and 2 and is shown as a radial or side fed modular blown film co-extrusion die generally as 100, having mounted thereon external melt inlet dividers 102 which are shown in schematic cross-sectional fashion in more detail in FIG. 3.

FIG. 1 shows a typical side fed modular blown film co-extrusion die 100, having the following major components, namely a number of pancake sections 110, and divider plates 142, wherein two pancake sections 110 and a divider plate 142 makes up one module 850. Side fed modular blown film co-extrusion die 100 in FIGS. 1,4 and 6 includes a bottom module 112, an intermediate module 116 and a top module 114, stacked one on top of each other and supported by support columns 130. Each module 850 includes an upper pancake section 811, a lower pancake section 813 and a divider plate 142 for separating top melt path 807 from bottom melt path 809. The adjacent upper and lower pancake sections 811 and 813 each face onto a central divider plate 142. Side fed modular blown film co-extrusion die is built up of any number of vertically stacked modules 850.

Side fed modular blown film co-extrusion die also normally includes an inner lip 122 and an outer lip 124 and a die exit or die lip 120, which is the termination point of the melt accumulation channel 140 which is also sometimes called an extrusion passage in the industry. Melt accumulation channel 140 is defined by central pin 118, together with pancake sections 110 in the assembled condition. Melt flows horizontally through the pancake sections 110 in the radial direction 126 towards the melt accumulation channel 140 and then upwardly in the axial direction 128, towards die exit or die lip 120 where the thin film is produced.

External melt inlet dividers 102 are attached externally to the pancake sections 110 as shown in FIG. 1 and more particularly shown in detail in FIG. 3.

FIG. 2 is a top schematic plan view of the side fed modular blown film co-extrusion die shown in FIG. 1, with the external melt inlet dividers 102 shown mounted radially around the outer circumference of the pancake sections 110.

Referring now to FIG. 3, the external melt inlet divider 102 includes the following major components, melt pipe 150, extruder adapter flange 152, melt flow channel 154, splitter block flange 156, splitter block 160 having melt entry channels 162 and adapted to fit into die entry port 180, adjacent pancake sections 110. Splitter block 160 of external melt inlet divider 102 further includes a upper melt channel 861 and a lower melt channel 862.

Optionally external inlet divider 102 also includes a valve 164 having a valve flange 166, a valve locking nut 170, a valve stem 168 and valve seat 172. With the addition of option valve 164, the division of flow within splitter block 160 between each melt entry channel 162 can be somewhat adjusted and controlled.

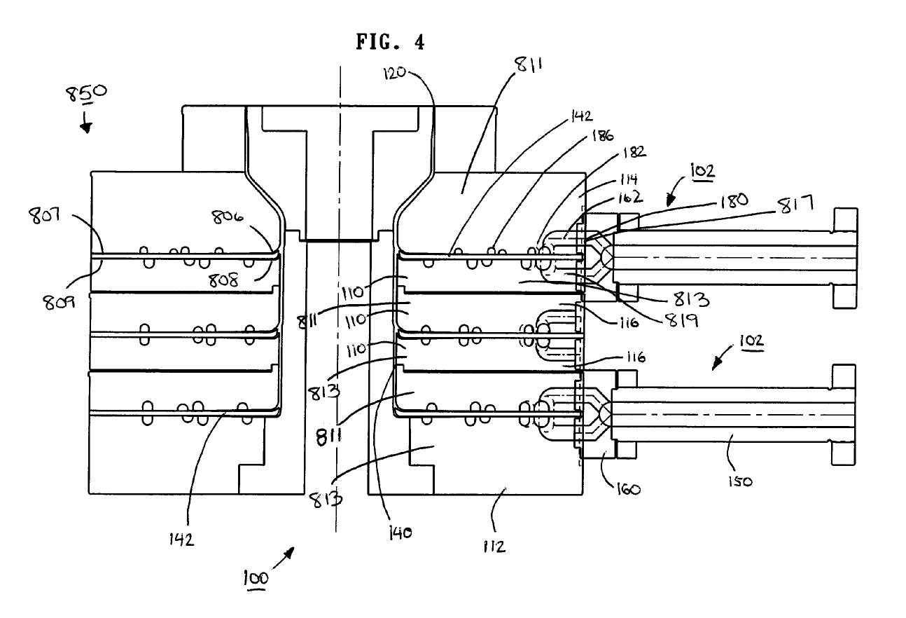

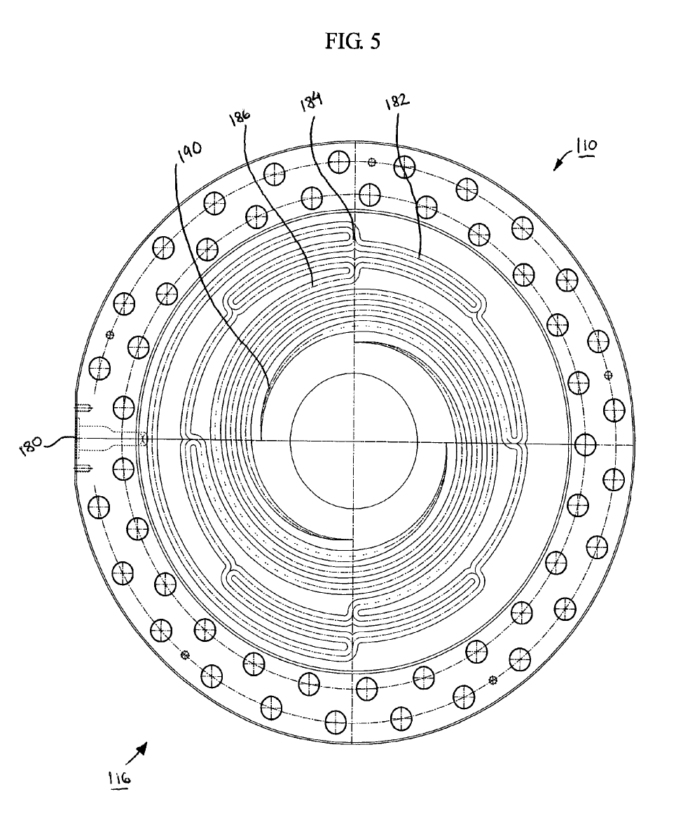

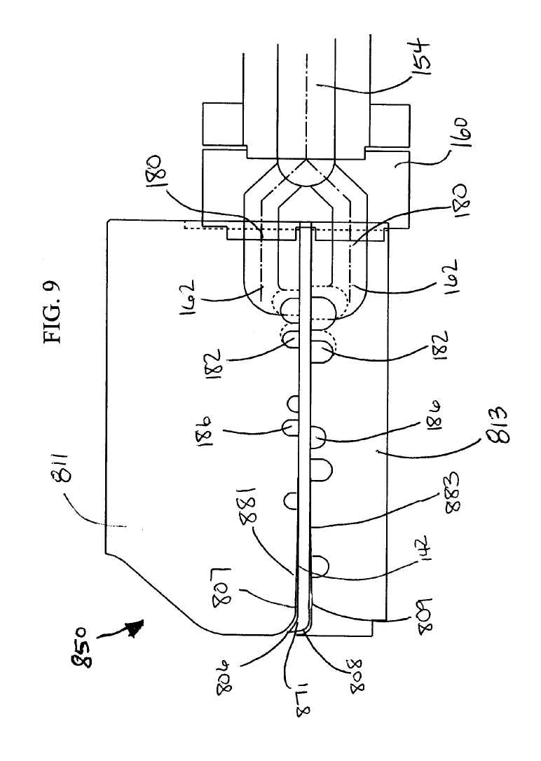

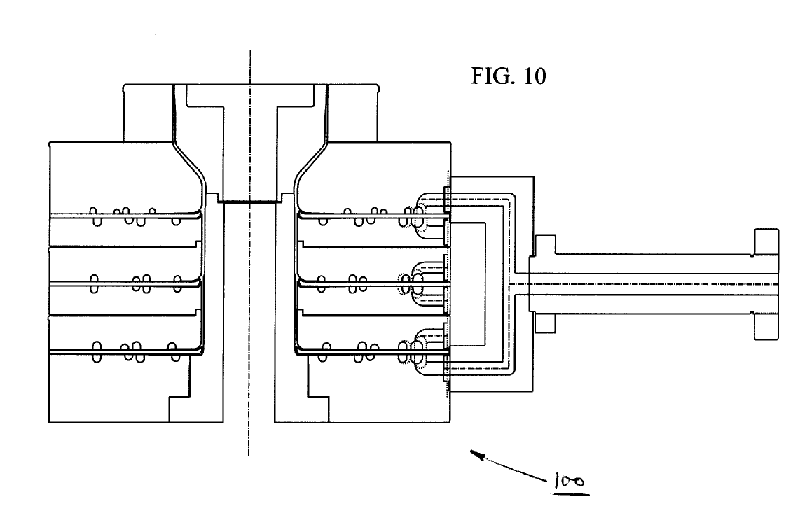

FIG. 4 shows schematically in cross-sectional view, alternate side fed modular blown film extrusion die 100 together with external melt inlet dividers 102 which in this case do not include valves 164. From this diagram it is apparent that each pancake section 110 would receive ½ of the melt received through each of the melt flow channels 154 within each melt pipe 150. Top melt path 807 for example includes melt received in each pancake section at melt entry port 180 shown in FIG. 5 which is directed initially through melt channels 182 which is further divided at melt bifurcation points 184 and eventually flows through melt spirals 186. The melt exits into melt accumulation channel 140 which is also sometimes termed as an extrusion passage 140. Top melt path 807 for example produces a top melt layer 806 and bottom melt path 809 produces a bottom layer 808. Top and bottom melt layers 806 and 808 may be selected to be the same or different melt compositions. Referring now to FIGS. 4 and 9, a divider plate 142 separates the melt paths of each of the pancake sections 110. In this manner, ½ of the melt received through melt flow channel 154 is divided and directed into separate pancake sections 110.

Module 750 of prior art devices shown in FIG. 8 includes a top melt path 707 and a bottom melt path 709. In the present invention, module 850 also includes a top melt path 807 which defines a top melt layer 806 in the finished product and a bottom melt path 809 which defines a bottom melt layer 808 in the finished product. Module 850 includes as shown in FIGS. 4 and 9 for example, an upper pancake section 811, a lower pancake section 813 seperated by relatively thin smooth divider plate 142. Divider plate 142 is preferably less than 3 inches thick and normally between ¼ inch and ½ inch thick. The melt channels 182 and the melt spirals 186 forming part of top melt path 807 form a top melt layer 806 in the finished product. Notably absent is internal melt divider 400 since each melt path 807 and 809 has its own independent melt entry port 180 and melt entry channel 162. In this manner if the same melt material is to be introduced along the top melt path 807 and the bottom melt path 809, then an external melt inlet divider 102 would be selected and attached to the respective melt entry ports 180 defined on each pancake section 110.

On the other hand, if one selects to have a different polymer and/or melt introduced along top melt path 807 and the bottom melt path 809, then a single melt inlet 302 would be attached to each individual melt entry port 180, of each individual pancake section 110. In this manner, one could introduce a different melt polymer along top melt path 807 and bottom melt path 809.

Module 850 as shown in FIGS. 4 and 9 includes an upper pancake section 811 defining a top melt path 807 and a lower pancake section 813 defining a bottom melt path 809, the pancake sections 811 and 813 separated by a substantially smooth flat divider plate 142.

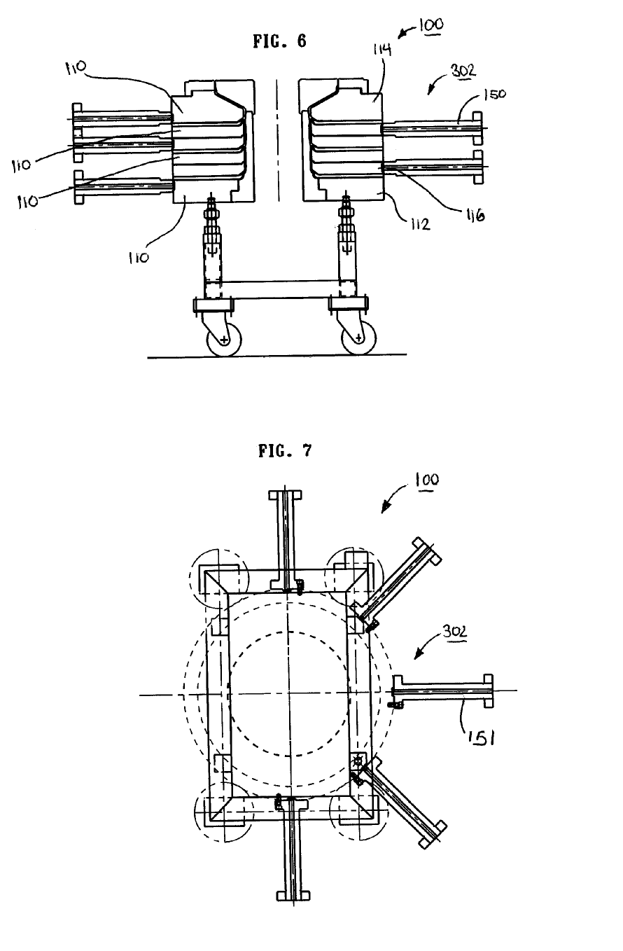

Referring now to FIGS. 6 and 7, rather than using external melt inlet dividers 102 as shown in FIGS. 1, 3 and 4, one could use single melt inlets 302 as shown in FIG. 6 in which case, each pancake section 110 would be fed by an individual single melt inlet 302, thereby effectively doubling the number of polymer layers that could be extruded through one module.

Referring to FIG. 9 divider plate 142 is substantially planar and smooth with an upturned end 871. Divider plate 142 having smooth upper surface 881 and a smooth lower surface 883 in that there are no melt channels 182 or melt spirals 186 defined in divider plate 142.

In Use

Referring first of all to the prior art diagram shown in FIG. 8 which has an internal melt divider 400, one will note that internal melt divider 400 is located after the die entry port 180 and is internal to the side fed modular blown film co-extrusion die. In other words, with this type of die, only one type of polymer can be fed into the two sets of melt channels 182 that are located within the module. To run more melts additional modules would have to be used or added. This can be a time consuming and expensive process making this type of extrusion die very inflexible in terms of being able to quickly select different numbers of polymer to be extruded through the die.

In practise, customer requirements may require films being made that have any number of layers or components. On each pancake section 110 the melt channels 182 and melt spirals 186, potentially could provide a separate layer to the extrusion film as required by the customer. With the prior art device, one is limited to one polymer being used in both the top melt path 707 and bottom melt path 709, of the device shown in FIG. 8.

The present invention shown in FIGS. 4 and 9, the extrusion machine by way of example only is comprised of three modules 850 namely bottom module 112, intermediate module 116 and top module 114. Each pancake section 110 has an individual melt entry port 180. The number of melt layers one is able to extrude is limited only to the number of melt entry ports in the side fed modular blown film co-extrusion die. In FIGS. 1 and 4 for example, a total of six separate entry ports 180 are defined in six separate pancake sections 110. This is double the number that would be available in the prior art modules.

As shown in FIG. 6, each of these melt entry ports 180 could be fed by single melt inlets 302 as shown in FIG. 6 and this would require each single melt inlet 302 to be connected at the extruder adapter flange 152 to six separate extruders.

On the other hand if one wishes to produce a film having three separate layers, one could use external melt inlet dividers 102 which divides the melt received through melt flow channel 154 in splitter block 160 into two melt entry channels 162 which are connected to melt entry ports 180 of pancake section 110. In this manner, one can use three extruders attached to each of the external melt inlet dividers and feed six melt entry ports 180 with three different polymers.

It will be apparent to a person skilled in the art that any combination of external melt inlet dividers 102 and single melt inlets 302 can be used, such that any number of individual polymers can be introduced into side said modular blown film co-extrusion die from one to six in any combination thereof. For example, one could include two external melt inlet dividers 102 and two single melt inlets 302 for a combination of four polymers being fed into side fed modular blown film co-extrusion die.

This provides the operator of side fed modular blown film co-extrusion die with great flexibility to be able to produce film having any number of layers from one to six inclusively. In the prior art devices, in order to achieve this, one would have to take apart the entire machine and replace the pancake sections and/or add a pancake section as required in order to produce the number of layers required by the customer.

By providing for external melt inlet dividers 102, rather than internal melt divider 400, the side fed modular blown film co-extrusion die become much more flexible and user friendly and more efficient to operate and run. In addition, the capital cost for purchasing these machines is reduced, in that with the same number of pancake sections, one is able to produce film having a number of different layers, rather than having to have additional pancake sections 110 available for increasing the number of layers.

In addition to external melt inlet dividers 102, one can also fit them with a valve 164 shown in FIG. 3. In this manner, one can balance the flow of melt through melt entry channels 162 and therefore, the flow of melt into each individual melt entry port 180.

With the present invention, one can run separate polymers by connecting additional extrudes to single melt inlets 302. One does not need to replace the die to increase or decrease the number of layers in the extruded polymer, but simply need to add or subtract the number of external melt inlet dividers 102 and/or single melt inlets 302.

It should be apparent to persons skilled in the arts that various modifications and adaptation of this structure described above are possible without departure from the spirit of the invention the scope of which defined in the appended claim.

What is claimed is:

1. A module used in a modular blown film co-extrusion die for extruding multi layer polymer materials in a tubular form, the module comprising:
(a) an upper pancake section including an upper melt entry port and melt channels defined in one face thereof, wherein the melt channels communicating fluidly with the upper melt entry port,
(b) a lower pancake section including a lower melt entry port and melt channels defined in one face thereof, wherein the melt channels communicating fluidly with the lower melt entry port, and
(c) wherein the melt channels of the upper and lower pancake sections facing each other and separated by a divider plate, such that the upper pancake section together with one side of the divider plate defining a top melt path and the lower pancake section together with the other side of the divider plate defining a bottom melt path, wherein the top melt path producing a top melt layer and the bottom melt path producing a bottom melt layer.

2. The module claimed in claim 1 wherein the divider plate being substantially planar.

3. The module claimed in claim 2 wherein the divider plate having substantially smooth upper and lower surfaces.

4. The module claimed in claim 3 wherein the divider plate including an upturned end.

5. The module claimed in claim 1 wherein each melt entry port operably dimensioned to be fed by individual extruders.

6. A modular blown film co-extrusion die for extruding multi-layer polymer materials in tubular form comprising at least one module as claimed in claim 1,2 or 3 including at least two melt entry ports wherein each entry port operably adapted to be fed by individual extruders and wherein each module capable of producing two independent melt layers.

7. A blown film co-extrusion die for extruding multi-layer polymer materials in tubular form comprising at least two modules as claimed in claim 1,2, or 3 stacked one on top of the other, the co-extrusion die including at least four melt entry ports wherein each entry port operably adapted to be fed by individual extruders and wherein each module capable of producing two independent melt layers.

8. The module claimed in claim 1 further including an external melt inlet divider for communicating polymer melts to multiple melt entry ports the external melt inlet divider including:
a) a melt pipe defining a melt flow channel for communicating melts there through,
b) a means for splitting the melt into at least two separate paths for communicating melt to at least two individual melt entry ports.

9. The module claimed in claim 8 wherein the splitting means includes a splitter block rigidly attached at one end of the melt pipe, the splitter block including an upper melt channel for communicating to an upper melt entry port and a lower melt channel for communicating melt to a lower melt entry port.

10. The module claimed in claim 8 wherein the splitter block further including a valve, wherein the valve for controlling the division of melt flow within the splitter block thereby controlling the melt flow to each melt entry port.
